(19) United States
(12) Patent Application Publication
(10) Pub. No.: US 2012/0060110 A1
(43) Pub. Date: Mar. 8, 2012

(54) NOTIFICATION BAR USER INTERFACE CONTROL

(75) Inventors: Ritika Virmani, Seattle, WA (US); Eugene Chang, Redmond, WA (US); Martin J. Hall, Seattle, WA (US); Jane T. Kim, Seattle, WA (US); Warren G. Stevens, Redmond, WA (US); Michael J. Ens, Redmond, WA (US); John H. Lueders, Seattle, WA (US); Prashant Singh, Bellevue, WA (US); Sarah J. Bowers, Snohomish, WA (US); Mike Pell, Woodinville, WA (US); Mary-Lynne Williams, Seattle, WA (US)

(73) Assignee: MICROSOFT CORPORATION, Redmond, WA (US)

(21) Appl. No.: 12/877,858

(22) Filed: Sep. 8, 2010

(51) Int. Cl. G06F 3/048

(52) U.S. Cl. 715/771

(57) ABSTRACT

Various embodiments provide a notification bar user interface control that is designed to help users maintain focus on their browsing activities, while offering notifications in the form of suggestions. In at least some embodiments, the notification bar user interface control is non-modal and is presented at a location within the browsing field-of-view that is selected to reduce user distraction. Further, in at least some embodiments, the notification bar user interface control is presented in a manner which overlays content of the web page and thus, does not cause layout of the web page to be changed.

### BACKGROUND

Notifications that are generated in the context of a web browser tend to be modal notifications in the form of a dialog that blocks the user from their browsing task. Specifically, such notifications tend to be presented in the primary field of view, overlay and block content and, because of their modal nature, force a user to take some action before being able to return to their browsing task.

These types of notifications can be distracting and annoying for many users. Moreover, requiring a user to take an action before allowing them to return to the browsing task can degrade the user experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a notification bar user interface control that is designed to help users maintain focus on their browsing activities, while offering notifications in the form of suggestions. In at least some embodiments, the notification bar user interface control is non-modal and is presented at a location within the browsing field-of-view that is selected to reduce user distraction. Further, in at least some embodiments, the notification bar user interface control is presented in a manner which overlays content of the web page and thus, does not cause layout of the web page to be changed.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates an example web browser in accordance with one or more embodiments.

FIG. 3 illustrates a notification bar in more detail in accordance with one or more embodiments.

FIG. 4 is a flow diagram that describes steps a method in accordance with one or more embodiments.

FIG. 5 illustrates an example system that can be used to implement one or more embodiments.

### DETAILED DESCRIPTION

Overview

Various embodiments provide a notification bar user interface control, also referred to as a “notification bar,” that is designed to help users maintain focus on their browsing activities, while offering notifications in the form of suggestions. In at least some embodiments, the notification bar user interface control is non-modal and is presented at a location within the browsing field-of-view that is selected to reduce user distraction. For example, in the embodiments described below, the notification bar is presented at or near the bottom of a web browser's user interface. The notification bar is designed to be noticeable yet ignorable, thus enabling a user to continue with their browsing tasks without being distracted by a modal dialog. Further, in at least some embodiments, the notification bar user interface control is presented in a manner which overlays content of the web page and thus, does not cause layout of the web page to be changed.

In the discussion that follows, a section entitled “Operating Environment” is provided and describes one environment in which one or more embodiments can be employed. Following this, a section entitled “Example Notification Bar” describes an example notification bar in accordance with one or more embodiments. This section includes multiple subsections that describe various features in accordance with one or more embodiments. Next, a section entitled “Example Method” describes an example method in accordance with one or more embodiments. Last, a section entitled “Example System” describes an example system that can be utilized to implement one or more embodiments.

Operating Environment

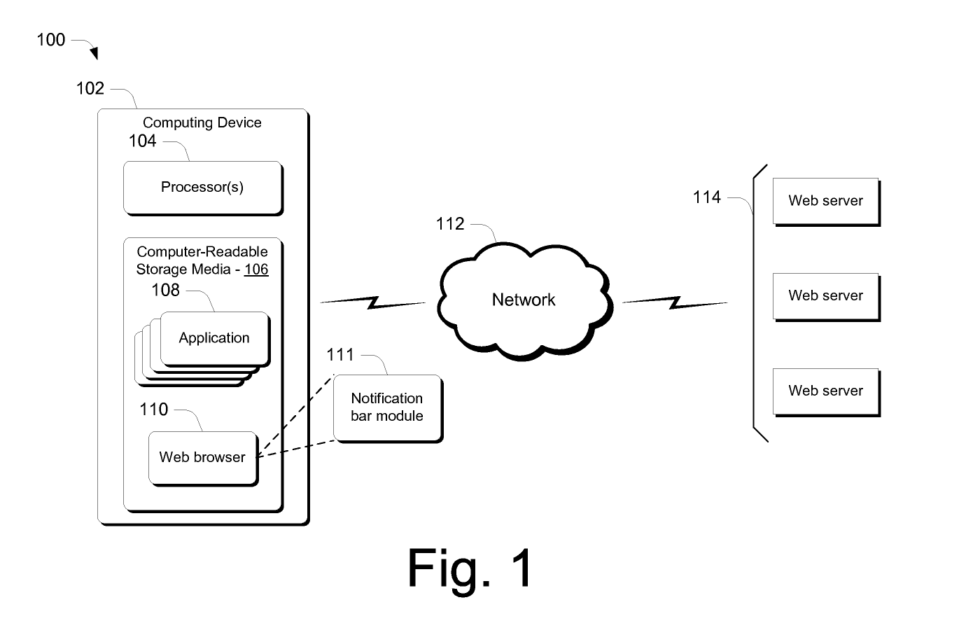

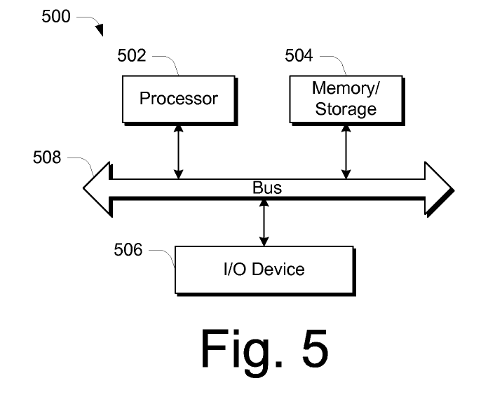

FIG. 1 illustrates an operating environment in accordance with one or more embodiments, generally at 100. Environment 100 includes a computing device 102 having one or more processors 104, one or more computer-readable storage media 106 and one or more applications 108 that reside on the computer-readable storage media and which are executable by the processor(s). The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 5.

In addition, computing device 102 includes a software application in the form of a web browser 110 that includes or otherwise makes use of a notification bar module 111 that operates as described above and below. The notification bar module provides a notification bar that is designed to help users maintain focus on their browsing activities, while offering notifications in the form of suggestions. In at least some embodiments, the notification bar is non-modal and is presented at a location within the browsing field-of-view that is selected to reduce user distraction. Further, in at least some embodiments, the notification bar user interface control is presented in a manner which overlays content of the web page and thus, does not cause layout of the web page to be changed.

In addition, environment 100 includes a network 112, such as the Internet, and one or more web servers 114 from and to which content can be received and sent, as described above and below. Such content can include web pages that are received from the web servers.

Computing device 102 can be embodied as any suitable computing device such as, by way of example and not limitation, a desktop computer, a portable computer, a handheld computer such as a personal digital assistant (PDA), cell phone, and the like.

Having described an example operating environment, consider now a discussion of some example embodiments that can utilize notification bar module 111.

Example Notification Bar

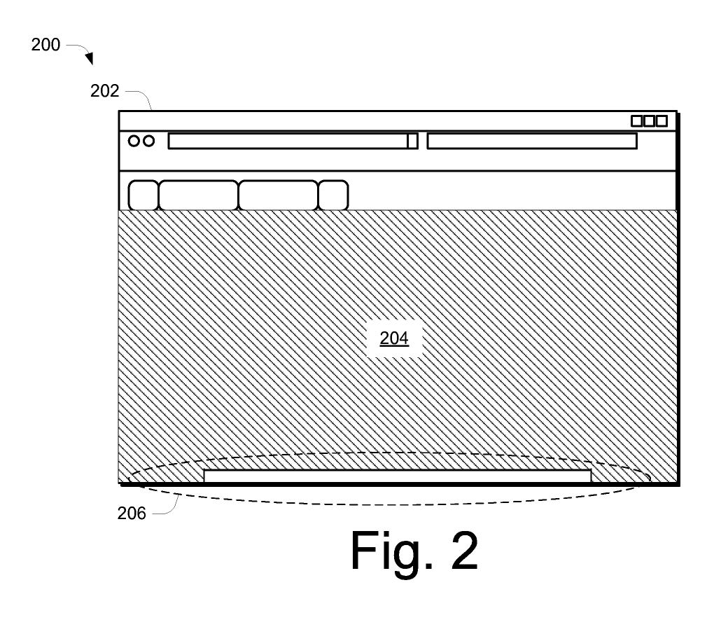

FIG. 2 illustrates an example web browser, in accordance with one or more embodiments, generally at 200. Web browser 200 includes a web browser user interface 202 which includes typical instrumentalities such as back and forward navigation buttons, an address bar, a search bar, and a tab band that can support multiple tabs, all of which are undesignated. The web browser user interface also includes a content rendering area 204 (designated by the cross hatching) in which content can be rendered. In addition, web browser user interface 202 includes a notification bar 206. In one or more embodiments, the notification bar is designed to help users maintain focus on their browsing activities, while offering notifications in the form of suggestions.

In at least some embodiments, the notification bar is non-modal and is presented at a location within the browsing field-of-view that is selected to reduce user distraction. For example, in the illustrated and described embodiment, the notification bar is presented as an overlay at or near the bottom of the web browser's user interface—here adjacent the bottom of or below content rendering area 204. The notification bar is designed to be noticeable yet ignorable, thus enabling a user to continue with their browsing tasks in content rendering area 204, without being distracted by a modal dialog. Further, in at least some embodiments, the notification bar user interface control is presented in a manner which overlays content of the web page and thus, does not cause layout of the web page to be changed. Here, by virtue of being presented at the bottom of the web browser user interface adjacent content rendering area 204, content rendered within the content rendering area is generally not obscured by notification bar 206. Thus, the notification bar's location effectively prioritizes content that is rendered within content rendering area 204 over a particular notification that might appear in the notification bar.

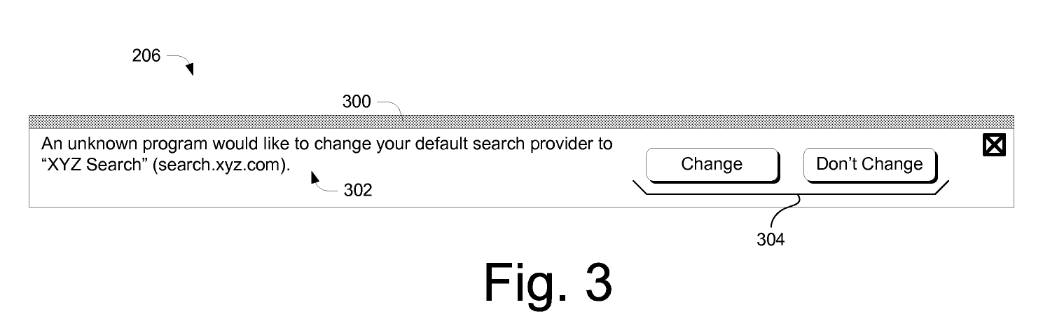

FIG. 3 illustrates notification bar 206 in more detail, in accordance with one or more embodiments. In this example, notification bar 206 includes a color bar 300 that extends horizontally across the notification bar, a textual notification area 302, and, optionally, one or more user-selectable instrumentalities such as the illustrated buttons shown generally at 304, and/or one or more links.

With respect to the color bar 300, consider the following. In one or more embodiments, the design of the notification bar, including the color bar 300, is intended to be more browser-centric than website-centric. Specifically, the notification bar is designed so that visually, it appears to have originated from the browser or operating system and not from a website. To this end, the color of the color bar can be selected to have a color scheme that is similar to or the same as the color scheme of notifications that emanate from the operating system or the web browser. Accordingly, any suitable color can be selected as the color of the color bar 300. Further, the color bar can also serve to visually separate notifications that appear in the notification bar and the content that is rendered in the content rendering area 204 (FIG. 2).

With respect to the textual notification area 302, any suitable type of textual notification can appear in this area. Such can include, by way of example and not limitation, security notifications, notifications associated with file download operations, notifications associated with saving user information, notifications associated with remembering items that are typed into web-based forms, notifications associated with privacy decisions, and the like.

Having considered an example notification bar in accordance with one or more embodiments, consider now some additional features that can be provided in accordance with one or more embodiments. Each of the features appears under its own separate subheading.

Format

Recall that one of the characteristics of the notification bar is that it has been designed in such a way to reduce distractions and interruptions and allow users to continue their browsing and focus on websites. In the past, browsers would tend to present modal dialogues that would force a user to take an action before allowing them to return to their browsing activities. To this end, in one or more embodiments, the web browser can now automatically make decisions that were formerly made by users, and utilize the notification bar to provide suggestions with respect to decisions that are automatically made by the web browser. For example, the web browser can make decisions, by default, that are intended to keep the user and/or web browser secure. The notification bar can be utilized to enable the user to opt out of the decision that is made by the web browser.

For example, in the past in at least some web browsers, notifications were provided in the context of so-called mixed content. Specifically, if a user opted to view content that was both secure and unsecure, a modal dialog would be presented informing the user of the presence of both secure and unsecure content and asking the user if they wanted to continue viewing the content. In one or more embodiments, a decision can be automatically made by the web browser to keep the web browser secure. The notification bar can then be used to ask the user whether they wish to download the unsecure content. Doing so, in these embodiments, removes a performance task from the user by having the web browser automatically default to a secure mode. The user can, as appropriate, still choose to act on the suggestion that appears in the notification bar. Alternately, the user can choose to ignore the suggestion that appears in the notification bar.

Avoiding Page Re-Sizing

In some instances in the past, notifications such as so-called “information bar” notifications would change the layout area and cause the webpage rendered by the web browser to be re-sized or re-laid out. This could take time depending on the complexity of a particular webpage. In one or more embodiments, a performance improvement is achieved by overlaying the notification bar within the content rendering area rather than, and without resizing the webpage.

Z-Order

As will be appreciated by the skilled artisan, content that is rendered within a webpage can have a so-called z-order. The z-order defines the stack order of elements that appear in a webpage. An element with a higher stack order or z-order will appear in front of elements with lower stack orders or z-orders. In one or more embodiments, the z-order of the notification bar is higher than the z-order of elements that appear in a webpage. This prevents web content from drawing on top of the notification bar.

Multiple Bars

In at least some embodiments, in order to maintain a clean user experience, a single notification bar is shown at any one time. In a situation where multiple notifications might apply, notification bars can be queued up so that once one is presented and addressed or removed from context, the next notification bar can be shown.

In one or more embodiments, in the context of multiple notification bars, a decision to display a particular notification bar can be made in accordance with a priority that is assigned to a particular notification bar. For example, notification bars that are user initiated can be given a high priority than other notification bars. As an example, when a user chooses to download a file, notification bars associated with this action are given priority over other notifications. Notification bars that are actionable and which could improve a user's browsing experience substantially, can be given a next lower priority. In addition, other notifications that have a tendency to be less interacted with by users can be given lower priorities. Essentially then, if a notification bar is currently presented and a new, higher-priority notification is warranted due to some encountered situation, such as a new file download, the new, higher-priority notification can be presented in front of the current notification bar.

One consideration associated with assigning priorities can include historical knowledge of those notifications that users tend to interact with more rather than less. Those notifications that tend to be interacted with more by users, can be given a higher priority than less interacted-with notifications.

Persistence Model

In one or more embodiments, notification bars can persist beyond a single navigation in contexts where it makes sense to persist them across navigations. That is, sometimes a website can cause a redirection to another page. In this instance, the notification bar can persist across these redirections if contextually appropriate. This can allow users to continue tasks that they initiated and accept a notification bar's suggestion a little later at a time of their convenience. For example, assume that a user logs onto their web-based e-mail account. Responsive to logging onto their e-mail account, they might be presented with a notification bar that asks whether the user wishes to have their password saved. The user might then click on their inbox and respond to a received e-mail. After responding to an e-mail, the user might then decide to act upon the notification bar's suggestion. Note that in this example the notification bar has persisted across multiple navigations. If, however, the user navigates to a context outside of their current e-mail context, the notification bar can be removed.

Notification Levels

In one or more embodiments, notifications can be provided by the notification bar in accordance with different levels, depending on the context of the web browser and/or navigation activities. As an example, in at least some embodiments, notifications can come at three different levels—a frame level, a page/tab level, and a security domain level.

Notifications that occur at the frame level are not specific to any particular tab to which a user may have navigated. For example, if a user deletes their browsing history, then a notification might be presented indicating that the browsing history has been deleted. These notifications can be seen across tabs while browsing in the current window.

Notifications that appear at the page/tab level have context with respect to a page or a tab to which the user has navigated. For example, if a user has navigated to a particular page to log into one of their accounts, a notification bar might be presented to include a notification that asks if the user would like to have their password saved for the account.

Notifications that appear with respect to the security domain level can be specific to particular domain associated with the user navigation. For example, if the user navigates to XYZ.com and chooses to download a particular file via a download acceptance notification bar, the user has made a trust decision associated with that domain. If, for some reason, the user or website navigates to a different website or changes domains, then their previous trust decision may no longer be based on their initial navigation where the download was initiated. Accordingly, the download acceptance notification bar can be removed to reduce the chance that the user would be tricked into making a trust decision associated with the new, wrong domain.

Resizing the Window

In one or more embodiments, if a web browser window is resized for some reason, an effort is made to not truncate the notification bar so as to obscure the notification. That is, the notification bar will, for a period of time as the web browser window is resized, grow vertically in an effort to not remove the text or content. There is however a threshold which, if exceeded, will result in truncation of user selectable buttons first, before truncation of the text of the notification. This is done so that the user will not click on a button without having textual material to read for context.

Having described various embodiments associated with notification bars, consider now an example method in accordance with one or more embodiments.

Example Method

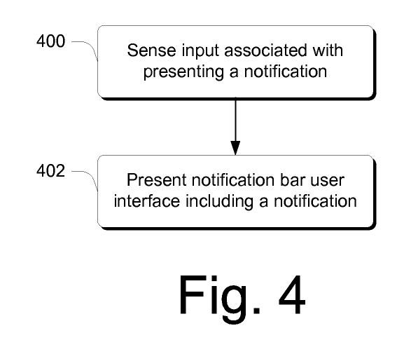

FIG. 4 is a flow diagram that describes steps a method in accordance with one or more embodiments. The method can be implemented in connection with any suitable hardware, software, firmware, or combination thereof. In at least some embodiments, the method can be implemented in software in the form of a web browser and/or a notification bar module, such as the ones described above.

Step 400 senses an input associated with presenting a notification. Such input can comprise any suitable type of input. For example, some types of input can be received from third parties, such as a third-party website that attempts to take action with respect to a webpage to which a user has navigated and accessed with a web browser. Alternately or additionally, some types of input can be received from a user, such as an attempt to download a file.

Step 402 presents, responsive to sensing the input, a notification bar user interface that includes a notification. Examples of notification bars are described above.

Having described an example method that can be utilized in accordance with one more embodiments, consider now an example system that can be utilized to implement one or more embodiments.

Example System

FIG. 5 illustrates an example computing device 500 that can be used to implement the various embodiments described above. Computing device 500 can be, for example, computing device 102 or web server 114 of FIG. 1.

Computing device 500 includes one or more processors or processing units 502, one or more memory and/or storage components 504, one or more input/output (I/O) devices 506, and a bus 508 that allows the various components and devices to communicate with one another. Bus 508 represents one or more of any of several types of bus structures, including a memory bus or memory controller, a peripheral bus, an accelerated graphics port, and a processor or local bus using any of a variety of bus architectures. Bus 508 can include wired and/or wireless buses.

Memory/storage component 504 represents one or more computer storage media. Component 504 can include volatile media (such as random access memory (RAM)) and/or nonvolatile media (such as read only memory (ROM), Flash memory, optical disks, magnetic disks, and so forth). Component 504 can include fixed media (e.g., RAM, ROM, a fixed hard drive, etc.) as well as removable media (e.g., a Flash memory drive, a removable hard drive, an optical disk, and so forth).

One or more input/output devices 506 allow a user to enter commands and information to computing device 500, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide a notification bar user interface control that is designed to help users maintain focus on their browsing activities, while offering notifications in the form of suggestions. In at least some embodiments, the notification bar user interface control is non-modal and is presented at a location within the browsing field-of-view that is selected to reduce user distraction. Further, in at least some embodiments, the notification bar user interface control is presented in a manner which overlays content of the web page and thus, does not cause layout of the web page to be changed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer readable storage media embodying computer readable instructions comprising a notification bar module that is configured to implement a notification bar user interface control designed to be used with a web browser, wherein the notification bar user interface control is non-modal and is configured to be presented in a location within a browsing field-of-view adjacent a bottom of a content rendering area.

2. The one or more computer readable storage media of claim 1, wherein said notification bar module is configured to present said notification bar used interface responsive to receiving input from a third party website.

3. The one or more computer readable storage media of claim 1, wherein the notification bar user interface control includes a color bar that extends horizontally across the notification bar user interface control.

4. The one or more computer readable storage media of claim 1, wherein the notification bar user interface control includes a color bar that extends horizontally across the notification bar user interface control, and wherein the notification bar user interface control includes one or more user-selectable instrumentalities.

5. The one or more computer readable storage media of claim 1, wherein the notification bar user interface control includes a color bar that extends horizontally across the notification bar user interface control, and wherein the color bar has a color scheme that is similar to or the same as a color scheme of notifications that emanate from an operating system associated with the web browser or the web browser.

6. The one or more computer readable storage media of claim 1, wherein the notification bar user interface control includes a color bar that extends horizontally across the notification bar user interface control, and wherein the color bar is configured to visually separate notifications that appear in the notification bar user interface control and content that is rendered in the content rendering area.

7. The one or more computer readable storage media of claim 1, wherein the notification bar module is configured to utilize the notification bar user interface control to provide notifications with respect to decisions that are automatically made by the web browser.

8. The one or more computer readable storage media of claim 1, wherein the notification bar module is configured to overlay the notification bar user interface control without causing a change in content layout size of an associated webpage.

9. The one or more computer readable storage media of claim 1, wherein the notification bar user interface control has a z-order that is higher than z-orders of elements that appear in a webpage rendered within the content rendering area.

10. The one or more computer readable storage media of claim 1, wherein the notification bar module is configured to queue up notification bar user interface controls so that a single notification bar user interface control is presented at any one time.

11. The one or more computer readable storage media of claim 1, wherein the notification bar module is configured to display notification bar user interface controls in accordance with a priority that is assigned to individual notification bar user interface controls.

12. The one or more computer readable storage media of claim 1, wherein the notification bar module is configured to enable a notification bar user interface control to persist beyond a single navigation or be removed depending on navigation contexts.

13. The one or more computer readable storage media of claim 1, wherein the notification bar module is configured to provide notification bar user interface controls in accordance with different contextual levels.

14. The one or more computer readable storage media of claim 1, wherein the notification bar module is configured to provide notification bar user interface controls in accordance with different contextual levels, wherein the different contextual levels comprise a frame level, a page/tab level, and a security domain level.

15. The one or more computer readable storage media of claim 1, wherein the notification bar module is configured to truncate the notification bar user interface control, in event that an associated web browser window is resized, to attempt to not remove text of a notification.

16. One or more computer readable storage media embodying computer readable instructions comprising a notification bar module that is configured to implement a notification bar user interface control designed to be used with a web browser, wherein the notification bar user interface control is non-modal and is configured to be presented adjacent a bottom of a content rendering area of the web browser, wherein the notification bar user interface control includes a color bar that is configured to visually separate notifications that appear in the notification bar user interface control and content that is rendered in the content rendering area.

17. The one or more computer readable storage media of claim 16, wherein the notification bar user interface control includes one or more user-selectable instrumentalities.

18. A computer-implemented method comprising:
sensing an input associated with presenting a notification associated with a web browser; and
presenting, responsive to sensing the input, a notification bar user interface control that includes a notification, wherein the notification bar user interface control is non-modal and is presented adjacent a bottom of a content rendering area of the web browser.

19. The computer-implemented method of claim 18, wherein the notification bar user interface control includes a color bar that is configured to visually separate notifications that appear in the notification bar user interface control and content that is rendered in the content rendering area.

20. The computer-implemented method of claim 18, wherein said presenting is performed by overlaying the notification bar user interface control without causing a change in content layout of content that is rendered in the content rendering area.
